(19) United States
(12) Patent Application Publication
(10) Pub. No.: US 2016/0334131 A1
(43) Pub. Date: Nov. 17, 2016

(54) RESONATOR AND AIR FLOW PIPE HAVING RESONATOR

(71) Applicant: TIGERS POLYMER CORPORATION, Osaka (JP)

(72) Inventor: Minoru HASEGAWA, Hyogo (JP)

(21) Appl. No.: 14/867,642

(22) Filed: Sep. 28, 2015

(30) Foreign Application Priority Data
May 14, 2015 (JP) 2015-098951

(51) Int. Cl. F24F 13/24; G10K 11/175

(52) U.S. Cl. CPC F24F 13/24; G10K 11/175; F24F 2013/245

(57) ABSTRACT

A resonator according to this disclosure includes a volume chamber and a communicating portion. The volume chamber and an air flow passageway of an air flow pipe can be brought into communication with each other by the communicating portion, and at least a portion of the communicating portion provides an air-permeable portion formed from an air-permeable material.

### CROSS-REFERENCE TO RELATED APPLICATION

This application is based on Japanese Patent Application No. 2015-098951 filed with the Japan Patent Office on May 14, 2015, the entire content of which is hereby incorporated by reference.

### BACKGROUND

1. Technical Field

This disclosure relates to a resonator and an air flow pipe having a resonator.

2. Related Art

In an air flow pipe (so-called “air duct”, “air flow duct”, “air flow hose”, etc.) of an intake system of an internal combustion engine for a car, an air-conditioning system, a cooling air delivery system or the like, noise generated from a noise source such as an engine, a fan or a motor propagates inside an air flow passageway. Air column resonance occurs in the air flow pipe. Thus, there has been a demand for reducing noise.

A resonance-type silencer is known in the art as a technique for silencing noise of a particular frequency occurring in an air flow passageway.

For example, JP-A-06-081737 discloses a resonance silencing device including a Helmholtz-type resonator having a resonance chamber and a communicating portion (also referred to as a connecting portion, connecting tube, or connecting hole). A sound-absorbing material is provided in the communicating portion and the resonance chamber. JP-A-2009-250183 discloses providing an expanded section (resonance and providing a sound-absorbing material in the resonance chamber.

According to these techniques, it is possible to use a resonator to enhance the silencing effect by the sound-absorbing material while silencing noise of a particular frequency band.

In addition, as a technique for suppressing air column resonance occurring in the air flow pipe, a technique so-called “porous duct”, a technique to reduce noise propagating through the duct by providing an air-permeable portion in the duct wall formed from a non-air-permeable material to prevent the air column resonance in the duct system, is known in the art. For example, as a porous duct, the technique described in JP-A-2001-323353 is known in the art. A characteristic feature of this technique lies in a porous material, such as a non-woven fabric, having a moderate air-permeability attached to the duct wall so as to cover a hole provided in the middle section of the non-air-permeable duct wall. Thus, the space inside the duct and the outside space are brought into communication with each other through the porous material. Moreover, a porous duct described in JP-A-2001-323853 includes a non-woven fabric that is heat-welded to an opening at the tip of a small tubular portion, which is provided so as to project from the wall of the duct body. With such a duct, it is possible to suppress the occurrence of air column resonance in the duct system by adjusting the air permeability of the porous material. Thus, it is possible to reduce noise propagating through the duct system. This also provides an advantage that a non-woven fabric can be easily attached, and an advantage that the air flow resistance of the duct can be reduced.

### SUMMARY

A resonator according to this disclosure includes a volume chamber and a communicating portion. The volume chamber and an air flow passageway of an air flow pipe can be brought into communication with each other by the communicating portion; and at least a portion of the communicating portion provides an air-permeable portion formed from an air-permeable material.

### BRIEF DESCRIPTION OF DRAWINGS

FIG. 1 is a schematic diagram illustrating a resonator and an air flow pipe of a first embodiment;

FIG. 2 is a diagram illustrating an example of a component member of a communicating portion;

FIG. 3 is a graph illustrating the silencing effect of a resonator of the first embodiment (Example 1);

FIG. 4 is a graph illustrating the silencing effect of a resonator of Example 2;

FIG. 5 is a graph illustrating the silencing effect of a resonator of Example 3;

FIG. 6 is a graph illustrating the silencing effect of a resonator of Comparative Example;

FIG. 7 is a diagram illustrating another example of a component member of a communicating portion;

FIG. 8 is a diagram illustrating another example of a component member of a communicating portion; and

FIG. 9 is a schematic diagram illustrating a method of measuring the amount of sound attenuation.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The silencing technique of these resonators and the silencing technique of a porous duct are different from each other in terms of the silencing principle. This results in a difference in the silencing effect.

The resonator technique utilizes the fact that a resonator resonates at a particular frequency. That is, noise in the vicinity of the resonant frequency is allowed to be absorbed by the resonator in order to suppress the propagation of the noise to the exit of the duct. Based on the principle, the silencing effect can be obtained only for a frequency band in the vicinity of the resonant frequency of the resonator. On the other hand, based on the principle of the porous duct technique, a non-woven fabric having an adjusted air permeability, or the like, is attached to a hole provided in a portion of the duct where the sound pressure in the pipe increases due to air column resonance of the duct, in order to suppress air column resonance occurring in the duct.

No silencer has yet been realized that has both the silencing property of a resonance-type silencer capable of silencing noise in the vicinity of a particular resonant frequency and the silencing property of a porous duct capable of suppressing air column resonance of the duct.

An object of this disclosure is to provide a silencer that has both the silencing property of a resonator and the silencing property of a porous duct.

The inventors have found as a result of earnest studies that the above problem can be solved if at least a part of a communicating portion of a resonator is formed from an air-permeable material. Thus, the resonator and the air flow pipe of this disclosure have been completed.

A resonator according to this disclosure includes a volume chamber and a communicating portion. The volume chamber and an air flow passageway of an air flow pipe can be brought into communication with each other by the communicating portion; and at least a portion of the communicating portion provides an air-permeable portion formed from an air-permeable material (a first embodiment).

Examples of the air-permeable material include a non-woven fabric, a foamed resin, and a filter paper.

In the first embodiment, the entire communicating portion may be formed from an air-permeable material (a second embodiment). In the first and second embodiments, the air permeability of the air-permeable material may be in a range of 0.5 to 100 sec/300 cc (a third embodiment). Moreover, it is possible to obtain an air flow pipe having a resonator by providing any of the resonators of the first to third embodiments on an air flow pipe (a fourth embodiment).

By attaching a resonator (the first to third embodiments) of this disclosure on an air flow pipe and thus providing an air flow pipe having a resonator (the fourth embodiment), it is possible to suppress air column resonance of the air flow pipe while obtaining a silencing effect that is realized because of the resonator resonance at a particular frequency.

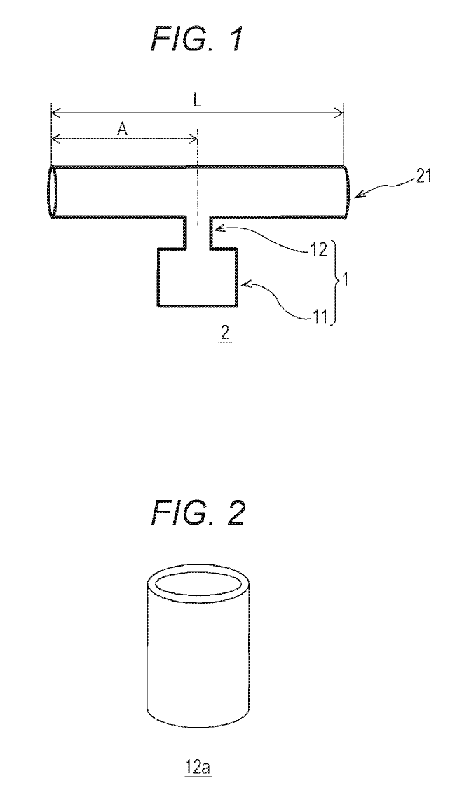

The embodiments of this disclosure will be described pith reference to the drawings. Note that, however, the disclosure is not limited the specific embodiments described below. Modifications to a part of any specific embodiment below shall fall within the scope of this disclosure. FIG. 1 is a schematic diagram illustrating a resonator and an air flow pipe of the first embodiment. An air flow pipe 2 is an air flow pipe with a resonator, and includes a resonator 1 The resonator 1 is attached to an air flow pipe body 21 having a total length L at a distance A from one end of the pipe. An air flow passageway is formed inside the air flow pipe body 21. An air flows through the air flow passage. The air flow pipe 2 having a resonator is used in, for example, an intake system or an exhaust system of an internal combustion engine for a car, an air flow system of an air-conditioning device, an air flow system of an air cooling system for a battery, or the like. The specific shape of the pipe of the air flow pipe body 21 is determined for each of various applications. The shape may be curved or bent as necessary. The air flow pipe body 21 may be a rigid pipe or a flexible hose.

The resonator 1 includes a volume chamber 11 and a communicating portion 12. The volume chamber 11 is formed from a non-air-permeable material and has a hollow box (container) shape. The volume chamber 11 has an expanded space inside, which has a predetermined volume. The expanded space and the outside air are blocked from each other by a non-air-permeable wall of the volume chamber 11. Typical examples of the material of the volume chamber include a thermoplastic resin such as a polypropylene resin, a thermosetting resin, and a metal.

The communicating portion 12 of the resonator is tubular, for example. The expanded space of the volume chamber 11 and the internal space (air flow passageway) of the air flow pipe body 21 are in communication with each other through the internal space of the communicating portion 12. With such a communicating structure, there is provided a so-called “Helmholtz-type resonator.”

At least a portion (hereinafter referred to as an “air-permeable portion” as necessary) of the communicating portion 12 is formed from an air-permeable material. That is, at least a portion of the communicating portion 12 forms an air-permeable portion. In the present embodiment, as illustrated in FIG. 2, a member 12a of the communicating portion 12 is entirely formed from an air-permeable material. Therefore, the entire communicating portion 12 is substantially air-permeable. Examples of the air-permeable material include a non-woven fabric, a foamed resin (foam sponge), and a filter paper. When a foamed resin is used, one may use a foamed resin having an open-celled structure. When the air-permeable material is a filter paper or a non-woven fabric, the air permeability may be adjusted by impregnating it with a binder, or the like. With the binder with which the material is impregnated, it is possible to increase the stiffness of the material, and to increase the shape retention property of the communicating portion component member 12a. In the present embodiment, the communicating portion component member 12a is formed by processing a non-woven fabric.

In the present embodiment, at least a portion of the communicating portion 12 forms an air-permeable portion. As the air-permeable portion has an air permeability, the air can move between the internal space of the communicating portion and the outside air through the air-permeable material of the air-permeable portion. When the entire communicating portion is formed from a non-air-permeable material, it prevents the air from moving between the inside and the outside of the communicating portion.

The air permeability of the air-permeable material of the communicating portion component member 12a will be described. The air permeability of the air-permeable material used in the resonator of the present embodiment is in a range of 0.5 to 100 sec/300 cc. The air permeability can be measured by a method in conformity with the Gurley test method defined in JIS P8117, for example. Particularly, the air permeability may be in a range of 1 to 50 sec/300 cc. The air permeability of an air-permeable material such as a non-woven fabric can be adjusted within such a range by utilizing a binder, a heat press, or the like, as necessary. Thus, the communicating portion component member 12a is formed.

The attachment of the air flow pipe body 21, the volume chamber 11 and the communicating portion (the communicating portion component member 12a) may be done by a known method such as welding, bonding, snap-in, engaging, locking, a band, a screw, or the like. The joint can be made by using a fitting structure in combination, for example, so that there will be no gap at the joint portion between the air flow pipe body 21 and the communicating portion component member 12a and the joint portion between the volume chamber 11 and the communicating portion component member 12a.

The functions and effects of the resonator and the air flow pipe of the embodiment described above will be described.

The resonator 1 of the embodiment described above resonates at a resonant frequency that is determined by the volume of the volume chamber, the length of the communicating portion, the cross-sectional area of the communicating portion, etc. Therefore, it is possible to reduce noise propagating through the inside of the air flow pipe body 21 in the vicinity of the resonant frequency. In this regard, similar effects to those of a conventional resonator are obtained.

Moreover, when the resonator 1 of the embodiment described above is attached to the air flow pipe body 21, there is an air-permeable portion of the communicating portion formed from an air-permeable material at a position in the vicinity of the pipe wall of the air flow pipe body 21. With this air-permeable portion, the air flow pipe 2 of the present embodiment can assume a similar configuration to that of a so-called “porous duct” (a duct of which holes provided in the pipe wall are covered by a non-woven fabric material, or the like). As a result, it is possible to suppress an increase of noise due column resonance occurring in the air flow pipe body 21. That is, the resonator 1 of the embodiment described above has both the silencing property of a resonator and the silencing property of a porous duct.

The effect described above will be demonstrated by way of testing. A straight pipe having a diameter of 80 mm and a length L=700 mm was used as the air flow pipe body 21. A resonator with a volume chamber having a volume of 2 l and a predetermined resonance frequency of 95 Hz was used as the resonator 1. The air flow pipe 2 with a resonator of the first embodiment was produced with the air flow pipe body 21 and the resonator 1. Note that a non-woven fabric having an air permeability of 10 sec/300 cc and a thickness of 1.5 mm was used as the communicating portion component member 12a of the communicating portion 12. The resonator 1 was attached at 233 mm from an end of the air flow pipe body 21, i.e., a position such that A=⅓*L is satisfied. Example 1 was carried out by using this air flow pipe 2.

For comparison, an air flow pipe with a resonator was produced, which was the same as the resonator 1 except that the communicating portion was formed from a non-air-permeable material. Comparative Example 1 was carried out by using the air flow pipe.

In examples and comparative examples, each silencing effect was checked by measuring the amount of sound attenuation. Note that the amount of sound attenuation is an indicator used for evaluating the silencing effect and is obtained as follows. That is the distal end of the air flow pipe 2 with a resonator, which is to be tested, is connected to a speaker device 99 for sound vibration as illustrated in FIG. 9. While the sound is emitted from the speaker, the sound pressure Pα (the sound pressure measured at a position α) on the exit side of the sound produced from the speaker (the distal end opening at the upstream of the duct), and the sound pressure Pβ (the sound pressure measured at a position β) on the sound source side (the distal end section at the downstream of the duct) are measured. An indicator represented by the ratio therebetween (Pβ/Pα) is obtained as the amount of sound attenuation. A larger value of the amount of sound attenuation means there is more silencing effect, and a smaller value of the amount of sound attenuation means there is less silencing effect.

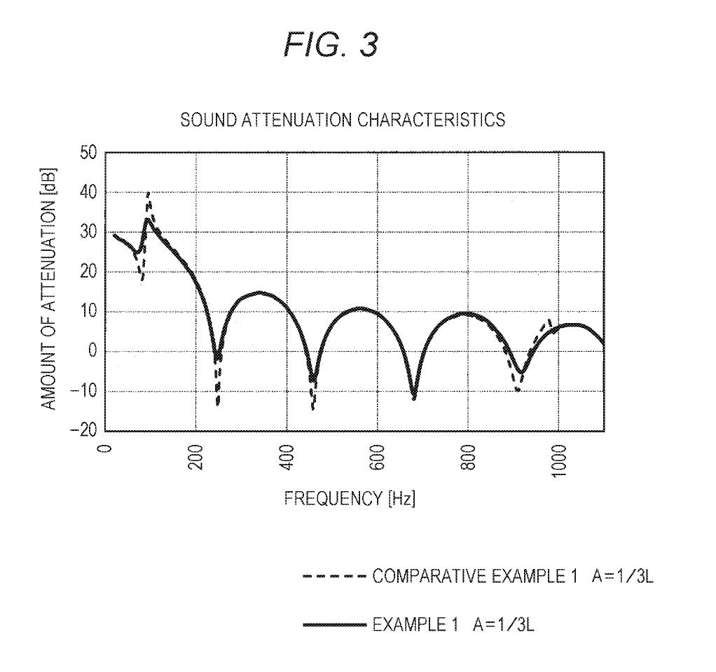

FIG. 3 illustrates the measurement results of the amount of sound attenuation for Example 1 and Comparative Example 1. The resonator of Example and Comparative Example are both resonating at 95 Hz, which is the predetermined resonance frequency of the resonator. Thus, there is obtained the silencing effect due to the resonance of the resonator.

Moreover, in Example 1 in which an air-permeable portion is provided in the communicating portion 12, the resonance of the resonator is milder. The drop of the amount of sound attenuation, which is observed in the vicinity of 80 Hz in Comparative Example 1, is reduced. Thus, it can be understood that the so-called “anti-resonance phenomenon”, which is observed when a resonator is provided, is reduced.

Moreover, in Example 1, the increase of the noise caused by air column resonance occurring in the air flow pipe body 21 is suppressed. That is, in Comparative Example 1, the drop of the amount of sound attenuation is observed due to air column resonance occurring in the air flow pipe body 21 (primary, secondary, third-order and fourth-order resonance) in the vicinity of 250 Hz, 455 Hz, 680 Hz and 910 Hz, respectively. In the vicinity of such a frequency, large noise occurs due to air column resonance in the air flow pipe of Comparative Example 1. In Example 1, on the other hand, there is a smaller drop of the amount of sound attenuation for air column resonance at 250 Hz, 455 Hz and 910 Hz (primary, secondary and fourth-order resonance, respectively). That is, in Example 1, these occurrences of air column resonance are suppressed.

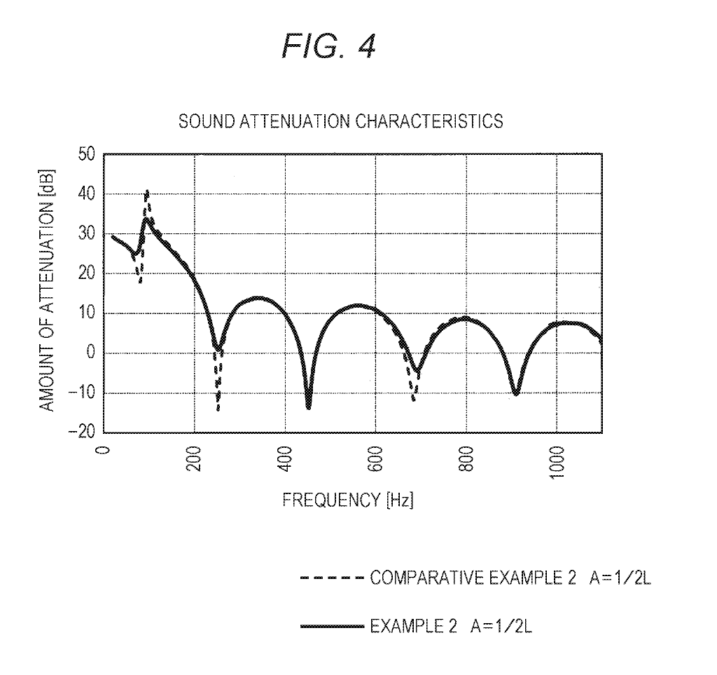

FIG. 4 is a graph illustrating the silencing effect for Example 2 and Comparative Example 2, which are obtained by varying the position at which the resonator is attached from Example 1 and Comparative Example 1 described above. In the present example and comparative example, the resonator was attached at a position such that A=350 mm, i.e., A=½*L, is satisfied. Also in Example 2, it can be observed that the example provides the silencing effect due to the resonance as a resonator as in Example 1, and that Example 2 can improve the drop of the amount of attenuation of anti-resonance appearing in the vicinity of 80 Hz in Comparative Example 2. Moreover, in Example 2, the drop of the amount of sound attenuation is reduced as compared with the primary and third-order air column resonance of the air flow pipe body 21 appearing at 250 Hz and 680 Hz. That is, in Example 2, these occurrences of air column resonance are suppressed.

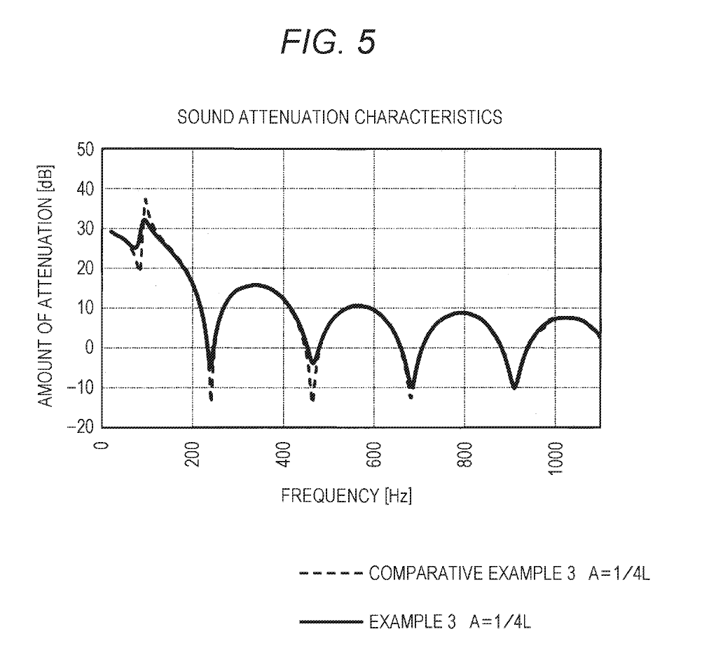

FIG. 5 is a graph illustrating the silencing effect for Example 3 and Comparative Example 3, which are obtained by varying the position at which the resonator is attached from Example 1 and Comparative Example 1 described above. In the present example and comparative example, the resonator was attached at a position such that A=175 mm, i.e., A=¼*L, is satisfied. Also in Example 3, it can be observed that the example provides the silencing effect due to the resonance as a resonator as in Example 1, and that Example 3 can improve the drop of the amount of attenuation of anti-resonance appearing in the vicinity of 80 Hz in Comparative Example 3. Moreover, in Example 3, the drop of the amount of sound attenuation is reduced as compared with the primary, the secondary and third-order air column resonance of the air flow pipe body 21 appearing at 250 Hz, 455 Hz and 680 Hz. That is, in Example 3, these occurrences of air column resonance are suppressed.

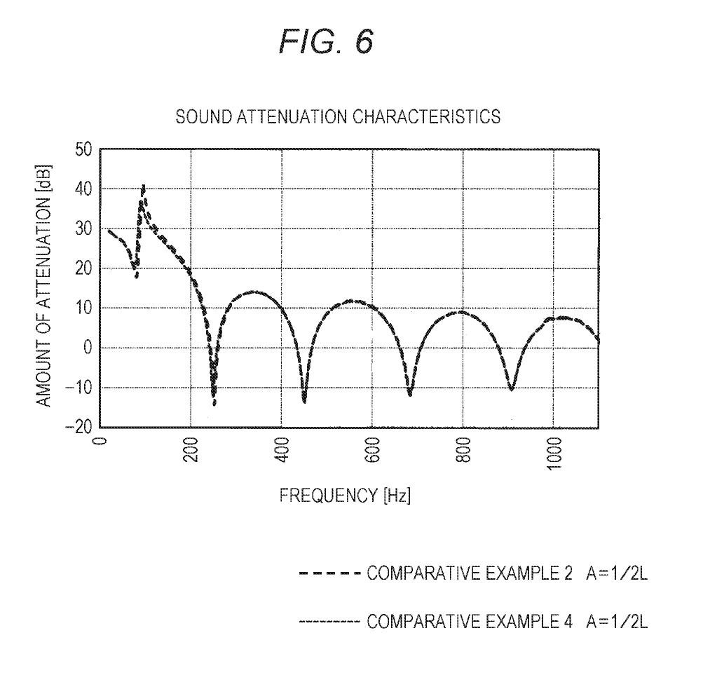

FIG. 6 illustrates the results for Comparative Example 4. The entire communicating portion of the resonator used in Comparative Example 4 is formed from a non-air-permeable material. Moreover, a sound-absorbing material made of a tubular non-woven fabric having a thickness of 1.5 mm is provided inside the communicating portion. The resonator is attached at such a position that A=½*L is satisfied. Comparative Example 4 and Comparative Example 2 are compared with each other. it can be seen that the results for Comparative Example 4, in which a sound-absorbing material is provided inside the non-air-permeable communicating portion, show substantially no difference from Comparative Example 2. That is, it is assumed that the effects observed in Examples 1 to 3 are those deriving from providing the communicating portion with a portion formed from an air-permeable material an air-permeable portion), thereby allowing the air to move between the internal space of the communicating portion and the outside air through the air-permeable material of the air-permeable portion.

As described above, it was confirmed from Examples 1 to 3 that the air flow pipe 2 with a resonator of the first embodiment has both the silencing property of a resonator and the silencing property of a porous duct. Moreover, was also confirmed that the air flow pipe 2 with a resonator of the first embodiment has an effect of suppressing the drop of the silencing effect due to anti-resonance of a resonator. Note that the position at which a resonator (a communicating portion including an air-permeable portion) is provided is also contributing to the effect of suppressing air column resonance of the air flow pipe. That is, in view of the resonance mode of the air column resonance occurring in the air flow pipe, if the resonator of the embodiment described above is provided at a position corresponding to a node of sound pressure mode (e.g., at a position of about ⅓ from a pipe end for third-order air column resonance), the resonance suppressing effect is less likely to be obtained for the air column resonance corresponding to that resonance mode. In this regard, it is similar to the conventional porous duct technique.

This disclosure is not limited to the embodiment described above. Other embodiments realized by making various modifications to the above embodiment shall fall within the scope of this disclosure, Other embodiments of this disclosure will be described below. The description below focuses on what is different from the embodiment described above. Detailed description of the same parts as those of the embodiment described above will be omitted, Embodiments realized by combining together parts of the embodiments below, and embodiments realized by substituting parts of the embodiments below with parts of other embodiments, shall also fall within the scope of this disclosure.

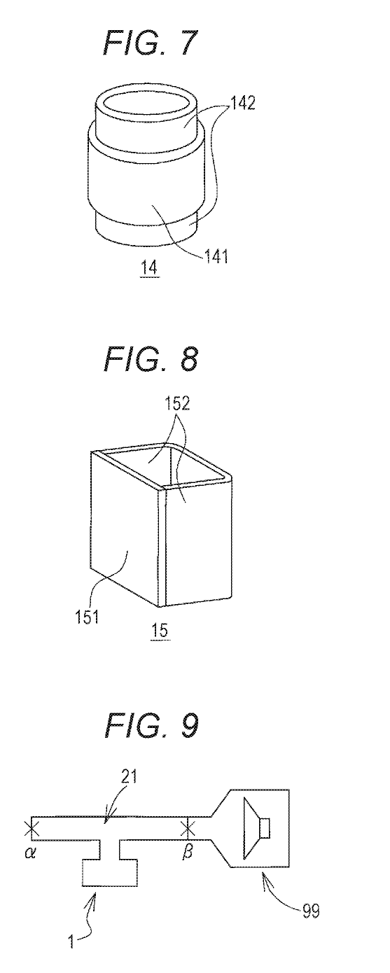

The following modifications for example can possibly be made to the specific configuration of the communicating portion 12. FIG. 7 illustrates another example of the communicating portion component member of the communicating portion. A communicating portion component member 14 is cylinder-shaped, and a ring-shaped air-permeable portion 141 formed from an air-permeable material is provided at a central portion of the communicating portion component member 14 in its longitudinal direction. Non-air-permeable portions 142 and 142 formed from a non-air-permeable material are provided so as to extend the opposite ends of the air-permeable portion 141. Thus, an air-permeable portion of an air-permeable material may be formed only in a part of the communicating portion of the resonator 1. That is, the communicating portion component member 14 can be expected to have a similar silencing effect to that of the communicating portion component member 12a. The communicating portion component member 14 having such a configuration can be manufactured by insert molding, or the like. Using the communicating portion component member 14 of the present embodiment, the opposite end portions of the communicating portion component member 14 can be formed from a non-air-permeable material, and it is therefore easy to integrate the communicating portion with the air flow pipe and the volume chamber.

Alternatively, a communicating portion component member forming a communicating portion as illustrated in FIG. 8 may be used. A communicating portion component member 15 is rectangular tube-shaped, and one wall of the rectangular tube is an air-permeable portion 151 of an air-permeable material. The other three walls are non-air-permeable portions 152 and 152 of a non-air-permeable material. Thus, an air-permeable portion of the communicating portion is provided in a partial area of the wall of the pipe-shaped communicating portion. That is, the communicating portion component member 15 can be expected to have a similar silencing effect to that of the communicating portion component member 12a. Since the communicating portion component member 15 of the present embodiment has a flat-surface air-permeable portion 151, it is easy to mold and integrate an air-permeable portion.

An air-permeable portion of a communicating portion having a different configuration may be used. For example, the air flow pipe body, the communicating portion and the volume chamber may be formed integral together utilizing blow molding or injection molding of a thermoplastic resin. A window (hole) is provided in the communicating portion. An air-permeable material such as a non-woven fabric can be integrated with the communicating portion so as to cover the window provided in the communicating portion. This integrated portion may form the air-permeable portion of the communicating portion.

There is no particular limitation on the specific shape and specifications of the volume chamber. The shape of the volume chamber is determined taking into consideration the required volume, the required amount of surrounding space, and the like. The volume chamber may include a so-called “drain hole”. A so-called “two-stage resonator” may be provided by placing a partition wall including a communicating hole inside the volume chamber. The volume chamber may include a sound-absorbing material therein.

An air flow pipe having a resonator of this disclosure may include a plurality o resonators of this disclosure. Moreover, an air flow pipe having a resonator of this disclosure may include a conventional resonator. In such cases, the resonators may have different resonant frequencies from one another. The distance A from the position at which the resonator is attached to the air flow pipe body to the end of the air flow pipe body may vary between these resonators.

Air flow pipes (so-called “air ducts”, “air flow ducts”, “air flow hoses”, etc.), which form a part of an intake system and a part of an exhaust pipe of an internal combustion engine for a car and an air-conditioning system and a cooling air delivery system, are illustrated herein as applications of the air flow pipe having a resonator of the embodiment described above. Note that, however, the applications are not limited thereto, and this disclosure may be applicable to technical fields and applications other than those illustrated herein.

An air flow pipe with a resonator having a desirable silencing effect of this disclosure can be used in air-delivery applications and are therefore highly industrially applicable.

A resonator configured to be connected to an air flow pipe of this disclosure may be any of first and second resonators below.

The first resonator is a resonator connected to an air flow pipe, the resonator including a volume chamber of a predetermined volume and a communicating portion for communicating between the volume chamber and the air flow passageway, wherein at least a portion of the communicating portion is formed from an air-permeable material so that an air can move between an internal space of the communicating portion and an outside air through the air-permeable material.

The second resonator is according to the first resonator, wherein the communicating portion is entirely formed from an air-permeable material.

An air flow pipe having a resonator includes the first or second resonator.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A resonator comprising:
a volume chamber; and
a communicating portion, wherein
the volume chamber and an air flow passageway of an air flow pipe are brought into communication with each other by the communicating portion, and
at least a portion of the communicating portion provides an air-permeable portion formed from an air-permeable material.

2. The resonator according to claim 1 wherein the entire communicating portion provides the air-permeable portion.

3. The resonator according to claim 1, wherein an air permeability of the air-permeable material is in a range of 0.5 to 100 sec/300 cc.

4. The resonator according to claim 2, wherein an air permeability of the air-permeable material is in a range 0.5 to 100 sec/300 cc.

5. An air flow pipe having the resonator according to claim 1.
